(19) United States
(12) Patent Application Publication
(10) Pub. No.: US 2008/0195252 A1
(43) Pub. Date: Aug. 14, 2008

(54) Device for dispensing beverages in glasses

(76) Inventors: Gianni Innocenti, Cavriglia (IT); Fabio Frasi, San Giovanni Valdarno (IT)

Correspondence Address: MODIANO & ASSOCIATI, Via Meravigli, 16, Milano, 20123, omitted

(21) Appl. No.: 12/068,372

(22) Filed: Feb. 6, 2008

(30) Foreign Application Priority Data
Feb. 8, 2007 (IT) AR2007A000008

(51) Int. Cl. G06F 17/00; B67D 5/06

(52) U.S. Cl. 700/240; 222/23; 222/30

(57) ABSTRACT

A dispensing machine with one or more dispensing stations, each provided with a transceiver antenna connected to the programmed electronic unit of the machine. Each dispensing station accommodates a bottle of beverage to be dispensed, having a transponder card, bearing information and/or parameters of the beverage contained therein, which, read by the corresponding transceiver antenna, are provided to the electronic unit, for processing. Each dispensing station has a load cell which weighs continuously the bottle, so that by establishing a difference of the weights measured at two different times it determines the amount of beverage poured in the time interval defined by said times.

The present invention relates to a device for dispensing beverages in glasses, suitable to be installed in places frequented by many people, such as catering places, through which one or more beverages are dispensed into glasses.

### BACKGROUND OF THE INVENTION

In the background art, dispensing machines are known which are provided with dispensing stations, each provided with a bottled beverage to be dispensed.

Known machines have auxiliary means, such as tags which bear the indication of the beverages to be served, a system for refrigerating the served beverages, buttons for dispensing each beverage, usually a plurality of buttons by means of which the user or the operator controls, for example, the dispensing of the amount suitable for a small glass, a medium glass, and a large glass. Other machines provide for control of dispensing by means of a programmed magnetic card, which is read by a suitable reader associated with the machine, with the magnetic card, for example, being of the prepaid type and with the indication of the type of beverage and amount to be dispensed, et cetera.

Known machines with one or more dispensing stations, with manual or magnetic card-driven activation, store the characteristics of the beverage to be dispensed in each station, such as the amount of beverage to be dispensed, the corresponding costs, which change from one beverage to another and therefore from one station to another, and in any case store all the parameters that allow dispensing and indication of the cost of what has been dispensed.

In the case of machines with a plurality of dispensing stations, the programmed electronic unit contains the information associated with each dispensing station, with the information of each station referred to a specific beverage to be dispensed. When a beverage is changed in a station, therefore when one bottle is replaced with another one of a different value and type, it is necessary to store the new parameters related to that station in which the change of beverage to be dispensed has occurred.

Changing the programmed data related to each individual dispensing station, however, is a task which entails a relatively long intervention and therefore makes it inconvenient to replace one beverage with a different one during periods when the dispensing machine is active to serve patrons. Another drawback of known machines is due to the fact that the temporary replacement of a bottle which contains a low-value beverage with one which contains a high-value beverage, which therefore has a much higher cost, is not detected by the machine itself, and therefore the manager is cheated by users or by the operator when bottles with beverages of different cost are swapped in the machine and the dispensing button related to the low-value beverage is activated while, as a consequence of the swap, it dispenses the high-value beverage. This occurs both in the case of a machine with a single dispensing station and in the case of machines with a plurality of dispensing stations.

In known machines, the beverage is dispensed by introducing in the bottle that contains it a neutral gas under pressure, such as for example carbon dioxide or nitrogen.

The dispensed amount of beverage is determined by measuring the pressure of the gas introduced in the bottle and measuring the dispensing time interval. This determination, however, leads to incorrect results and therefore to dispensings which are different from the intended ones in terms of weight. The amount of beverage that is dispensed in fact depends on the speed within the dispensing duct and, for an equal pressure of the gas introduced in the bottle, on the level of the beverage within the bottle. The greater the difference in level between the top of the dispensing duct and the level of the beverage inside the bottle, the lower the dispensing speed and therefore the lower the amount of beverage dispensed in the same time interval being considered.

### SUMMARY OF THE INVENTION

The aim of the present invention to provide a dispensing machine for dispensing beverages which prevents the dispensing of a higher-value beverage instead of a lower-value beverage and therefore prevents fraud which damages the manager of the catering place or the customer being served.

Within this aim, an object of the present invention is to provide a dispensing machine with one or more dispensing stations, which allows rapid replacement of a bottle of beverage with another bottle of a different quality and/or type, so as to allow replacement of the bottles of beverages in the dispensing machine even during hours of service in which the beverages are dispensed, without requiring interventions on the information stored in the programmed electronic unit of the machine.

Another object of the invention is to provide a dispensing machine in which the amount of beverage dispensed is the intended one, with minimal tolerances, regardless of the level of the beverage to be dispensed inside the bottle that contains it.

The invention that has allowed to achieve these results is constituted by a dispensing machine with one or more dispensing stations, which has, at each of said stations, a transceiver antenna, which is connected to the programmed electronic unit of the machine, and transponder tags or cards, each of which bears the information and/or parameters of the beverage to be identified, to be applied to the bottles to be loaded into the machine, so that the activation of the dispensing button or control that corresponds to the position of each bottle activates the programmed electronic unit with the parameters of the beverage that are present in the transponder tag or card applied in the bottle located in the seat of the activated dispenser.

Finally, the machine comprises, for each dispensing station, a load cell which continuously measures the weight of the bottle and of what is connected thereto, so that by means of the difference between the weights measured at successive times the weight, and therefore the amount of beverage poured between the compared times, is determined.

Such a machine is particularly advantageous, since it allows rapid replacement of bottles of beverages with others which may even have a different content, without having to perform any intervention on the data programmed in the machine, so as to allow replacement of one or more bottles, even mutually different ones, during the hours of service in which the machine is frequently activated.

It is advantageous because the quality and cost of the poured product are related to the content of the activated bottle, regardless of the position or dispensing station in which the bottle is placed.

It is advantageous because the transponder tag or card contains the information of the beverage contained in the bottle to which it is applied, said information being stored outside of service hours without any hindrance in the hours in which beverages are dispensed.

It is advantageous because the application of the transponder tag or card with the information stored therein to the bottle, normally to its base, is quick and safe and therefore can be performed even during service hours, when the beverages are being dispensed.

It is advantageous because the measurement of the weight, therefore of the quantity of beverage dispensed, is safe and entails long-tested weighing means which are therefore guaranteed, easy to apply and have a low cost.

### BRIEF DESCRIPTION OF THE DRAWINGS

This aim and these and other advantages will be understood easily, particularly by persons skilled in the art, by reading the detailed description that follows, which relates to a practical embodiment of the invention, illustrated merely by way of example in the accompanying drawings, in which:

FIG. 1 is a block diagram which exemplifies the functional logic of the machine;

FIG. 2 is a schematic view of the essential structure of the machine with reference to a dispensing station.

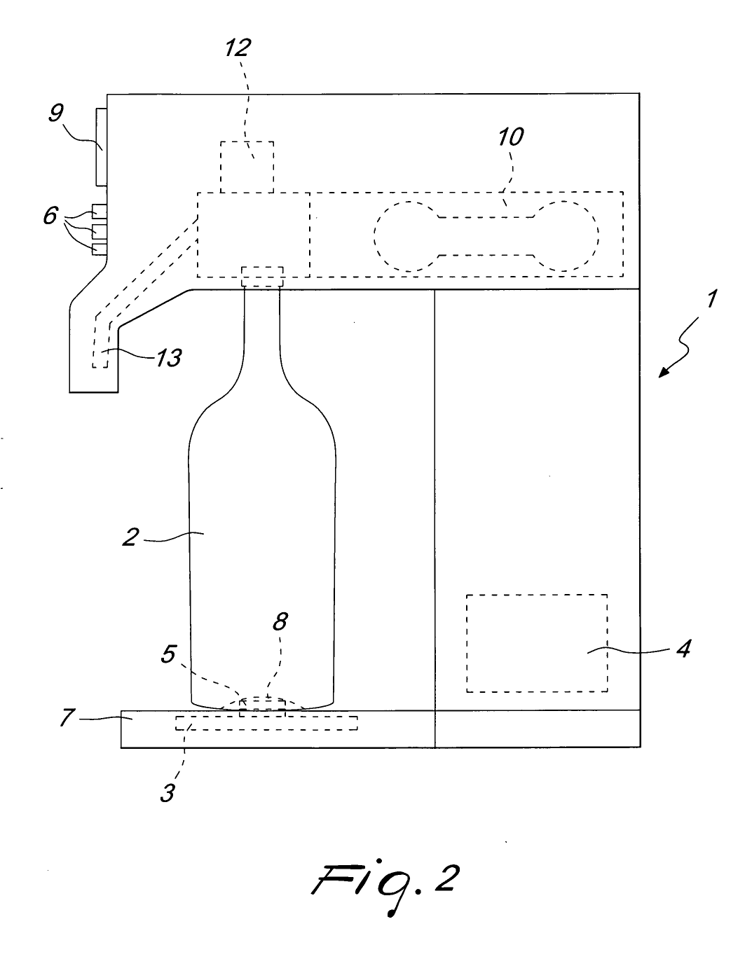

### DESCRIPTION OF THE PREFERRED EMBODIMENTS

Substantially, the invention relates to a dispensing machine 1 which dispenses beverages contained in bottles 2 or any other suitable container, hereinafter generically referenced by the term “bottle” for the sake of brevity, to be poured into glasses, in one or more doses for each type of beverage, with the machine 1 provided with one or more dispensing stations and therefore accommodating one or more bottles 2, the content of which can be poured even simultaneously.

Each dispensing station is provided with its own transceiver antenna 3, which is connected to a programmed electronic control unit 4 of the machine 1. The antenna 3 is adapted to communicate with a transponder tag or card 5 which is arranged close to it, hereinafter referenced by the term “card” for the sake of brevity, which bears the information and/or parameters of the beverage contained in the bottle 2 with which the transponder card 5 is associated. The transponder card 5 is therefore located in the body of the bottle 2, in a position or area suitable for being read by the transceiver antenna 3 in the dispensing station in which the bottle 2 is positioned.

The dispensing machine 1 may therefore be preferably equipped with several transceiver antennas 3, one for each dispensing station, and each one is located in the position suitable to interact and communicate with the transponder card 5 associated with the bottle 2 arranged in the dispensing station. The activation of the button or of one of the buttons 6 associated with a dispensing station therefore determines, on the part of the programmed electronic control unit 4 of the machine 1, the processing of the data associated with the bottle 2 and therefore with the dispensed beverage, read by the corresponding transceiver antenna 3.

Normally, the transceiver antenna 3 is arranged in the supporting base 7 for supporting bottles of the dispensing station in which the bottle 2 with the beverage to be dispensed is arranged, and in this case the transponder card 5 is applied to the body of the bottle 2 and in particular to the base 8 of the bottle, therefore in a position suitable to allow it to communicate with the corresponding transceiver antenna 3.

The programmed electronic control unit 4 is provided, in a known manner, with a dedicated software, a memory means and is adapted to process the information contained in the transceiver card 5 associated with the dispensing station activated by the operator or by the user to drive, according to what is provided in said program, the dispensing in the required and/or intended amount. In other words, the dispensing of a predefined fixed quantity of the chosen beverage, in the case of a single activation button 6 for each dispensing station; the dispensing of the minimum quantity, of the medium quantity or of the maximum quantity chosen in the case of three separate activation buttons 6 in each dispensing station. The same applies to other solutions with a different number of dispensing buttons or of dispensing driving means. Normally, at each dispensing station the machine 1 also has a display 9, on which the programmed electronic control unit 4 indicates the type and the characteristics of the beverage contained in the bottle 2, arranged in said station.

The replacement, in a dispensing station, of a bottle 2 with another different one therefore changes the information content indicated on the corresponding display 9 and the corresponding processing when the activation button is actuated.

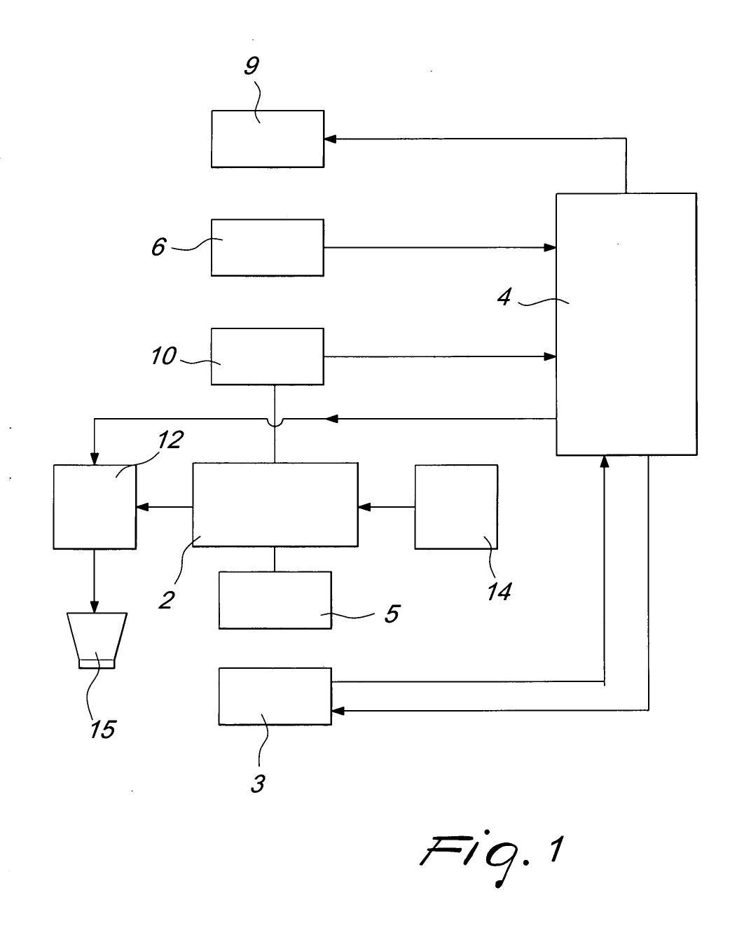

The programmed electronic unit 4, as shown schematically in FIG. 1, is therefore connected, in the preferred embodiment, to the display 9, to the buttons 6, one or more for each dispensing station, to the weighing assembly 10 or load cell, as specified hereinafter, to the transceiver antenna 3 of the dispensing station, and to the dispensing valve 12, which is open or closed in order to allow or stop dispensing when the intended weight of the dispensed beverage is reached.

Each dispensing station is therefore provided with a load cell 10, i.e., with a weighing assembly which is connected to the programmed electronic unit 4, by means of which the bottle 2 with the liquid contained therein and all that is connected thereto is weighed continuously, so that it is possible to determine continuously the variation of the measured weight and therefore the amount of beverage dispensed through the spout 13.

The electronic unit 4 is programmed to process the information received from various devices or units to which it is connected, and upon each activation by means of a button 6 or with another equivalent means, to drive the dispensing station and therefore control the dispensing of the amount of beverage programmed therein.

The individual bottles 2 in the dispensing stations are connected to a source 14 of pressurized gas, normally an inert gas such as nitrogen. They are further connected to the electric valve 12 and to the dispensing spout 13, so that upon activation of the corresponding dispensing control, the electric valve 12 opens and allows the beverage to flow out from the bottle 2, under the thrust applied by the pressurized gas that arrives from the source 14, normally a suitable tank, until the weight variation measured by the load cell 10 preferably corrected with the weight of gas introduced in the bottle corresponds to the amount of beverage to be poured. At this point, the electronic unit 4 controls the closure of the electric valve 12 and therefore stops the dispensing of the beverage.

The electronic unit 4 processes the weight variation measured by the load cell 10 and is programmed so as to correlate said measured weight variation to the volume of the beverage to be dispensed and normally preferably also to the weight of the gas introduced in the bottle in the place of the dispensed beverage, such as for the control of the contents of the bottle and of the dispensing quantity of beverage.

During production, the machine can be equipped with diversified auxiliary means and the individual units that compose it can be provided in various manners, without altering the functional logic on which the invention is based, without therefore said variations abandoning the scope of protection defined by the appended claims.

The disclosures in Italian Patent Application No. AR2007A000008 from which this application claims priority are incorporated herein by reference.

What is claimed is:

1. A device for dispensing beverages into glasses, comprising an electronic control unit and at least one dispensing station for pouring at least one beverage to consumers, the dispensing station comprising: a transceiver antenna, which is connected to the electronic control unit; a plurality of transponder cards, each of which is associated with a respective beverage bottle and bears information and/or parameters of a beverage to be dispensed that is contained in the bottle with which the transponder card is associated, each said transponder card being located in an area of the bottle that allows reading of the information borne by way of the transceiver antenna upon positioning of the bottle in the dispensing station; a load cell connected to said electronic control unit, for continuously weighing the bottle with the liquid contained therein, and wherein said electronic control unit is provided with a dedicated software and memory means and is programmed to process information loaded in the memory means and information received at each activation of the dispensing station from said transponder cards and load cell and to drive dispensing of a requested beverage.

2. The dispensing device of claim 1, comprising a plurality of dispensing stations and a plurality of transceiver antennas, one for each dispensing station of the device, and wherein each one of said antennas is located in a position suitable to interact with the transponder card associated with the bottle arranged in a respective one of said plurality of dispensing stations.

3. The dispensing device of claim 1, wherein said at least one dispensing station comprises a supporting base for bottle supporting, said transceiver antenna being arranged in said base of said at least one dispensing station in which the bottle with the beverage to be dispensed is positioned.

4. The dispensing device of claim 1, wherein each said transponder card is applied to the body of the bottle containing a corresponding beverage to be dispensed.

5. The dispensing device of claim 1, wherein each said transponder card is applied to the base of a respective bottle containing a corresponding beverage to be dispensed.

6. The dispensing device of claim 1, wherein the programmed electronic control unit is programmed to process the information contained in the transponder card associated with the activated dispensing station upon each activation of the device and drives dispensing of a beverage in a required and/or intended amount.

7. The dispensing device of claim 1, provided with inert gas nitrogen under pressure, for propelling beverage contained in a bottle toward a dispensing spout of the dispensing station.

8. The dispensing device of claim 1, wherein the electronic control unit is programmed so as to correlate a weight variation measured by the load cell at least to the volume of beverage to be dispensed.

9. The dispensing device of claim 1, wherein the electronic control unit is programmed so as to correct a weight variation during beverage dispensing measured at two different times with a weight of gas introduced in the bottle between said two times so as to be able to establish a quantity of and to replace dispensed beverage.
